(19) United States
(12) Patent Application Publication
(10) Pub. No.: US 2002/0070217 A1
(43) Pub. Date: Jun. 13, 2002

(54) Permeation barrier fuel module cover assembly

(76) Inventors: Ulf Sawert, Grand Blanc, MI (US); Sharon Elizabeth Beyer, Grand Blanc, MI (US); William Stuart Zimmerman, Grand Blanc, MI (US); John J. Giacchina, Davison, MI (US)

Correspondence Address: DELPHI TECHNOLOGIES, INC., Legal Staff, P.O. Box 5052, Mail Code: 480-414-420, Troy, MI, 48007-5052, US

(21) Appl. No.: 09/731,464

(22) Filed: Dec. 7, 2000

(51) Int. Cl. B60P 3/00; B62D 33/00; B65D 88/12; F17C 13/06

(52) U.S. Cl. 220/254.1; 220/562; 220/582

(57) ABSTRACT

A permeation barrier fuel module cover assembly for a fuel tank of a vehicle includes a cover and a fuel permeation barrier layer attached to the cover to retard permeation of fuel through the cover.

### TECHNICAL FIELD

The present invention relates generally to fuel tanks for vehicles and, more particularly, to a permeation barrier fuel module cover assembly for a fuel tank of a vehicle.

### BACKGROUND OF THE INVENTION

It is known to provide a fuel tank such as a plastic fuel tank in a vehicle to hold fuel to be used by an engine of the vehicle. In such a fuel tank, a cover is provided for a fuel reservoir. The cover typically has fuel tubes, electrical connector, and rollover valve attached thereto.

In some vehicles, the cover is made of a plastic material. However, the plastic material has a relatively high permeability when used with fuels. With recent legislation to reduce hydrocarbon emissions, greater emphasis is needed to reduce/eliminate surfaces through which hydrocarbons can escape.

One commercial approach to resolve this concern regarding permeation is to thicken the walls of the fuel module cover, which increases the weight, cost, and reduces the features that can be provided in a design of the fuel module cover. Such a commercial approach is undesired.

Therefore, it is desirable to provide a fuel module cover for a fuel tank on a vehicle that has a more effective fuel permeation barrier to prevent evaporative emissions. It is also desirable to provide a permeation barrier fuel module cover for a vehicle that significantly reduces evaporative emissions and cost of the fuel module cover.

### SUMMARY OF THE INVENTION

It is, therefore, one object of the present invention to provide a new permeation barrier fuel module cover assembly for a vehicle.

It is another object of the present invention to provide a fuel module cover assembly that significantly reduces evaporative emissions and cost in comparison to current fuel module covers.

To achieve the foregoing objects, the present invention is a permeation barrier fuel module cover assembly for a fuel tank of a vehicle. The permeation barrier fuel module cover assembly includes a cover and a fuel permeation barrier layer attached to the cover to retard permeation of fuel through the cover.

One advantage of the present invention is that a permeation barrier fuel module cover assembly is provided for a fuel tank of a vehicle that has a more effective fuel permeation barrier leading to less evaporative emissions. Another advantage of the present invention is that the permeation barrier fuel module cover assembly uses a barrier layer, which provides for performance enhancement in permeation of polymer covers used on fuel modules by reducing the surface area through which hydrocarbons can escape. Yet another advantage of the present invention is that the permeation barrier fuel module cover assembly provides greater design flexibility in using polymers to manufacture covers, while the barrier material reduces permeation.

Other objects, features, and advantages of the present invention will be readily appreciated, as the same becomes better understood, after reading the subsequent description taken in conjunction with the accompanying drawings.

### BRIEF DESCRIPTION OF THE DRAWINGS

FIG. 1 is a perspective view of a permeation barrier fuel module cover assembly, according to the present invention, illustrated in operational relationship with a fuel tank.

FIG. 2 is a top perspective view of the permeation barrier fuel module cover assembly of FIG. 1.

FIG. 3 is a sectional view taken along line 33 of FIG. 2.

### DESCRIPTION OF THE PREFERRED EMBODIMENT

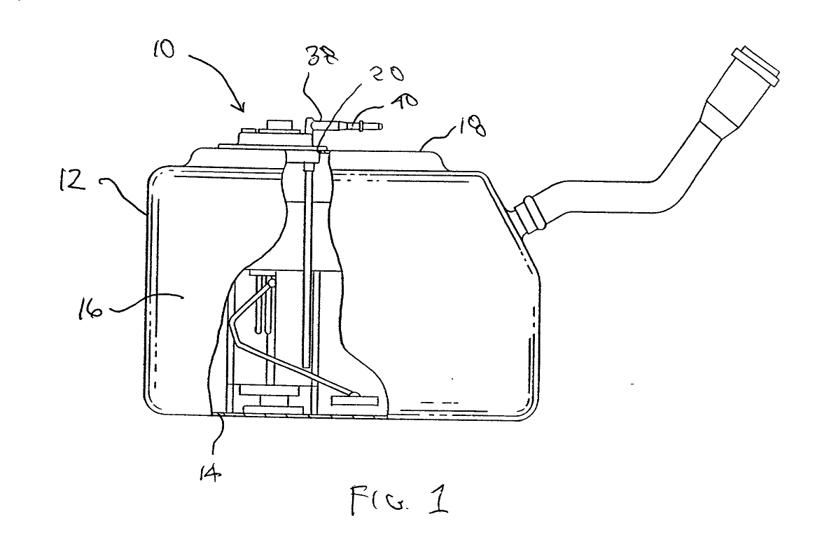

Referring to the drawings and in particular FIGS. 1 and 2, one embodiment of a permeation barrier fuel module cover 10, according to the present invention, is shown for a fuel tank 12 of a vehicle (not shown). The fuel tank 12 includes a bottom wall 14 and a side wall 16 around a periphery of the bottom wall 14 and extending generally perpendicular thereto. The fuel tank 12 also includes a top wall 18 around a periphery of the side wall 16 and extending generally perpendicular thereto and generally parallel to the bottom wall 14. The top wall 18 has at least one tank opening 20 therein for the permeation barrier fuel module cover assembly 10. The fuel tank 12 is made of a rigid material such as plastic. It should be appreciated that, except for the permeation barrier fuel module cover assembly 10, the fuel tank 12 is conventional and known in the art.

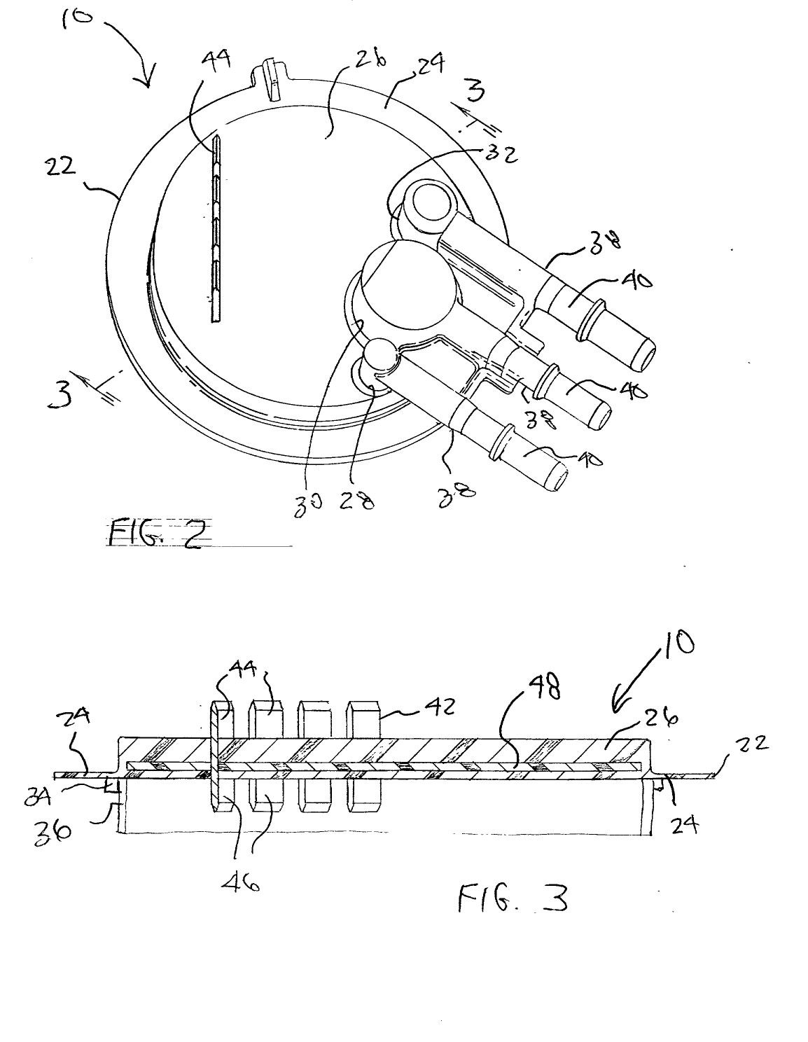

Referring to FIGS. 1 through 3, the permeation barrier fuel module cover assembly 10 includes a cover 22 to cover or close the opening 20. The cover 22 is generally circular in shape. The cover 22 is made from a plastic material such as polybutylene (PBT) or acetal (POM), which is a conventional material known in the art. The cover 22 includes a base wall 24 having a raised portion 26. The raised portion 26 has at least one, preferably a plurality of apertures 28, 30, and 32 extending therethrough for a function to be described. The cover 22 also includes a flange wall 34 extending under and radially inwardly from the base wall 24 in an overlapping manner. The cover 22 includes a skirt or side wall 36 extending generally perpendicular and axially from the flange wall 34. It should be appreciated that the cover 22 overlaps the tank opening 20 and is secured to an outer surface of the top wall 18 by suitable means such as a cam lock mechanism or retaining ring (not shown).

The permeation barrier fuel module cover assembly 10 also includes at least one, preferably a plurality of fuel tubes 38 extending through the cover 22. The fuel tubes 38 are generally “L” shaped and have an exterior or first portion 40 extending horizontally and an interior or second portion (not shown) extending vertically and through the apertures 28, 30, and 32. Each fuel tube 38 has a passageway (not shown) extending axially through the first portion 40 and second portion. It should be appreciated that the first portion 40 extends horizontally from the second portion for connection to a fuel hose or conduit (not shown) connected to an engine (not shown) of the vehicle. It should also be appreciated that the fuel tubes 38 are conventional and known in the art.

The permeation barrier fuel module cover assembly 10 includes at least one blade terminal 42 connected to the cover 22. The blade terminal 42 is generally rectangular in shape and made of an electrically conductive metal material such as copper. The blade terminal 42 includes a plurality of blades 44 spaced laterally and extending above the raised portion 26 for connection to an electrical connector (not shown). The blade terminal 42 also includes a plurality of blades 46 spaced laterally and extending below the base wall 24 for connection to an electrical connector (not shown). The blade terminal 42 is integral, unitary, and one-piece. It should be appreciated that the blade terminal 42 is attached to the cover 22 such as by insert molding.

The permeation barrier fuel module cover assembly 10 includes a fuel permeation barrier layer 48 connected to the cover 22. The fuel permeation barrier layer 48 is a made from a barrier material such as polyvinyl alcohol (PVOH), ethylene vinyl alcohol (EVOH), low carbon polyethylene (LCP), or polytetrafluoroethylene (PTFE), which are conventional materials known in the art. The fuel permeation barrier layer 48 has a predetermined thickness of approximately 0.2 millimeters to approximately 2.0 millimeters. The fuel permeation barrier layer 48 is used to cover the surface area inside of the skirt of the cover 22. The fuel permeation barrier layer 48 is generally circular in shape. Preferably, the fuel permeation barrier layer 48 is disposed between the base wall 24 and the raised portion 26 inside of the skirt. It should be appreciated that the fuel permeation barrier layer 48 could be placed at any suitable location inside the skirt of the cover 22. It should also be appreciated that the fuel permeation barrier layer 48 is attached to the cover 22 such as by insert molding.

In manufacturing the permeation barrier fuel module cover assembly 10, several conventional processes may be used. Preferably, the permeation barrier fuel module cover assembly 10 is formed by a method including the step of cutting a thin piece of die cut permeation barrier material to form the fuel permeation barrier layer 48. The method includes the step of providing the blade terminal 42 and loading the blade terminal 42 to the fuel permeation barrier layer 48 so that the fuel permeation barrier layer 48 becomes an insert mold carrier for the blade terminal 42. The method also includes the step of loading the fuel permeation barrier layer 48 and blade terminal 42 in a mold (not shown) to insert mold the cover 22 and overmolding the fuel permeation barrier layer 48 and blade terminal 42 into the cover 22. The method further includes the step of trimming the blade terminal 42 to electrically isolate the blades 44 and 46. The fuel tubes 38 are then connected to the cover 22. It should be appreciated that permeation barrier fuel module cover 22 is used to close or cover the tank opening 20 and the fuel permeation barrier layer 48 retards permeation of fuel through the cover 22 from the fuel tank 12.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

1. A permeation barrier fuel module cover assembly for a fuel tank of a vehicle comprising:
a cover; and
a fuel permeation barrier layer attached to said cover to retard permeation of fuel through said cover.

2. A permeation barrier fuel module cover assembly as set forth in claim 1 wherein said cover includes a base wall, a raised portion extending axially from said base wall, and a skirt extending axially from said base wall opposite said raised portion.

3. A permeation barrier fuel module cover assembly as set forth in claim 2 wherein said fuel permeation barrier layer is disposed within said skirt.

4. A permeation barrier fuel module cover assembly as set forth in claim 2 wherein said fuel permeation barrier layer is disposed between said base wall and said raised portion.

5. A permeation barrier fuel module cover assembly as set forth in claim 1 wherein said fuel permeation barrier layer is made from a material of one of a group comprising polyvinyl alcohol (PVOH), ethylene vinyl alcohol (EVOH), low carbon polyethylene (LCP), or polytetrafluoroethylene (PTFE).

6. A permeation barrier fuel module cover assembly as set forth in claim 5 including a blade terminal connected to said cover.

7. A permeation barrier fuel module cover assembly as set forth in claim 6 wherein said blade terminal is molded into said cover.

8. A permeation barrier fuel module cover assembly as set forth in claim 6 wherein said blade terminal extends through said cover.

9. A permeation barrier fuel module cover assembly as set forth in claim 1 wherein said fuel permeation barrier layer has a thickness of approximately 0.2 millimeters to approximately 2.0 millimeters.

10. A permeation barrier fuel module cover assembly as set forth in claim 1 including at least one fuel tube connected to said cover.

11. A permeation barrier fuel module cover assembly as set forth in claim 1 wherein said cover is made of a plastic material.

12. A permeation barrier fuel module cover assembly for a fuel tank of a vehicle comprising:
a cover having a base wall and a skirt extending axially from said base wall; and
a fuel permeation barrier layer attached to said cover inside of said skirt to retard permeation of fuel through said cover.

13. A permeation barrier fuel module cover assembly as set forth in claim 12 wherein said fuel permeation barrier layer has a thickness of approximately 0.2 millimeters to approximately 2.0 millimeters.

14. A permeation barrier fuel module cover assembly as set forth in claim 12 including at least one fuel tube connected to said cover.

15. A permeation barrier fuel module cover assembly as set forth in claim 12 including a blade terminal connected to said cover.

16. A permeation barrier fuel module cover assembly as set forth in claim 15 wherein said blade terminal is molded into said cover.

17. A permeation barrier fuel module cover assembly as set forth in claim 15 wherein said blade terminal extends through said cover.

18. A permeation barrier fuel module cover assembly as set forth in claim 12 wherein said fuel permeation barrier layer is made from a material of one of a group comprising polyvinyl alcohol (PVOH), ethylene vinyl alcohol (EVOH), low carbon polyethylene (LCP), or polytetrafluoroethylene (PTFE).

19. A permeation barrier fuel module cover assembly as set forth in claim 12 wherein said cover is made of a plastic material.

20. A permeation barrier fuel module cover assembly for a fuel tank of a vehicle comprising:
a cover having a base wall, a raised portion extending axially from said base wall, and a skirt extending axially from said base wall opposite said raised portion; and
a fuel permeation barrier layer disposed between said base wall and said raised portion inside of said skirt to retard permeation of fuel through said cover.
